(19) United States
(12) Patent Application Publication
(10) Pub. No.: US 2018/0321095 A1
(43) Pub. Date: Nov. 8, 2018

(54) HEALTH DEVICE

(71) Applicant: HON HAI PRECISION INDUSTRY CO., LTD., New Taipei (TW)

(72) Inventor: CHIEN-WEN WANG, New Taipei (TW)

(21) Appl. No.: 15/689,689

(22) Filed: Aug. 29, 2017

(30) Foreign Application Priority Data
May 4, 2017 (CN) 201710306968.0

(51) Int. Cl. G01L 1/10; G01L 19/00

(52) U.S. Cl. CPC G01L 1/106; A61H 2201/1207; A61H 2201/5071; G01L 19/0092

(57) ABSTRACT

A health device is also provided. The health device comprises a health device body and a pressure sensing system. The pressure sensing system is located on the health device body. The pressure sensing system comprises a plurality of pressure sensors, a reminder device a battery system, and a main circuit board. The plurality of pressure sensors is spaced from one another. The plurality of pressure sensors, the reminder device, and the battery system are electrically connected to the main circuit board.

### CROSS-REFERENCE TO RELATED APPLICATIONS

This application claims all benefits accruing under 35 U.S.C. § 119 from China Patent Application No. 201710306968.0, filed on May 4, 2017 in the China Intellectual Property Office, the contents of which are hereby incorporated by reference.

### FIELD

The subject matter herein generally relates to a health device with a pressure sensing system.

### BACKGROUND

A chronic unhealthy posture can lead to human skeletal deformation, and thus affect human health. For example, when people sit in a chair for a long time to learn or work, the unhealthy posture will make a spine deform. Currently, there is no health device that can monitor a user's posture in real time or give a warning to remind the user when he/she is seating with an unhealthy posture.

### BRIEF DESCRIPTION OF THE DRAWING

Implementations of the present technology will now be described, by way of example only, with reference to the attached figures, wherein:

FIG. 1 is a block diagram of one embodiment of a health device.

FIG. 2 is a structure schematic view of one embodiment of a pressure sensing system in a health device.

FIG. 3 is a structure schematic view of one embodiment of a health chair.

FIG. 4 is a structure schematic view of one embodiment of a health insole.

### DETAILED DESCRIPTION

The disclosure is illustrated by way of example and not by way of limitation in the figures of the accompanying drawings in which like references indicate similar elements. It should be noted that references to “another,” “an,” or “one” embodiment in this disclosure are not necessarily to the same embodiment, and such references mean “at least one.”

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape, or other feature which is described, such that the component need not be exactly or strictly conforming to such a feature. The term “comprise,” when utilized, means “include, but not necessarily limited to”; it specifically indicates open-ended inclusion or membership in the so-described combination, group, series, and the like.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

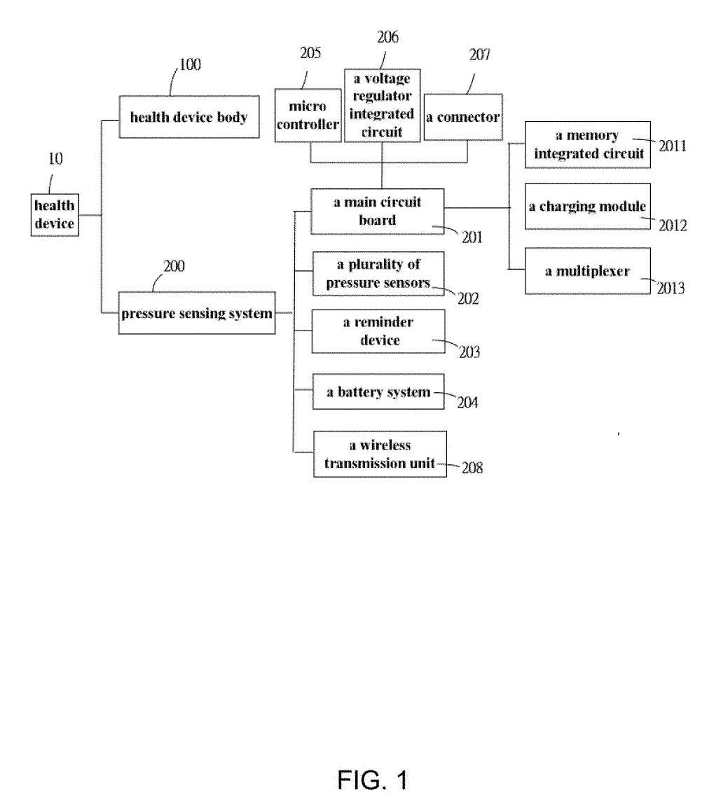

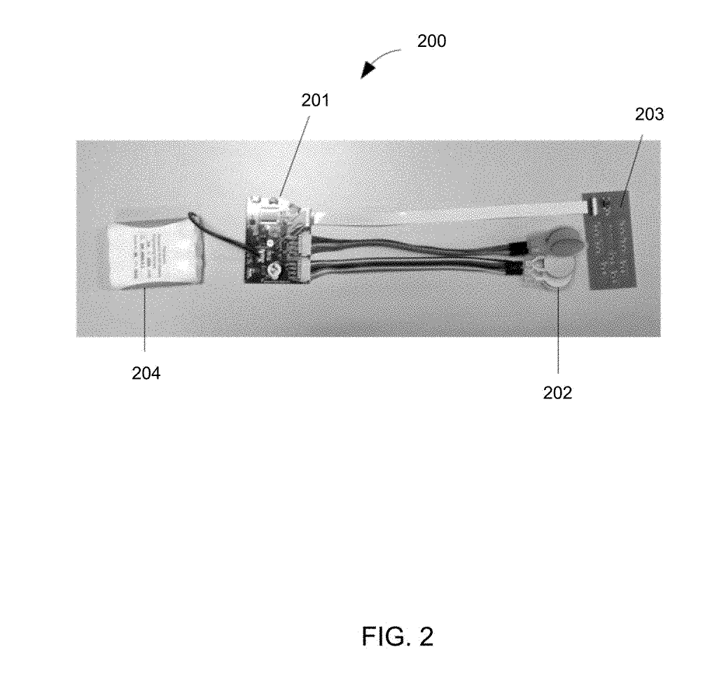

Referring to FIG. 1, the present disclosure is described in relation to a health device 10. The health device 10 may comprise a health device body 100 and a pressure sensing system 200. The pressure sensing system 200 may be located on the health device body 100. The pressure sensing system 200 comprises a main circuit board 201, a plurality of pressure sensors 202, a reminder device 203 and a battery system 204. The plurality of pressure sensors 202, the reminder device 203 and the battery system 204 are electrically connected to the main circuit board 201, as shown in FIG. 2. A micro controller (MCU) 205, a voltage regulator integrated circuit 206 and a connector 207 may be located on the main circuit board 201. The main circuit board 201 may further comprise a memory integrated circuit 2011, a charging module 2012, and a multiplexer 2013. In one embodiment, the pressure sensing system 200 further comprises a wireless transmission unit 208.

A structure of the health device 10 is not limited. The health device 10 may include an insole, a mattress, a chair or the like.

A size of the main circuit board 201 can be adjusted according to actual needs.

The wireless transmission unit 208 can be a Bluetooth wireless transmission unit or a WiFi wireless transmission unit. The wireless transmission unit 208 is used to transmit electrical signals to a mobile display device and display posture information of a user on the mobile display device. In one embodiment, the wireless transmission unit 208 is located in the micro controller 205. In another embodiment, the wireless transmission unit 208 is provided separately from the micro controller 205. The mobile display device comprises iOS software or android software. The mobile display device can be a mobile phone, a tablet PC, a notebook or the like.

The plurality of pressure sensors 202 can convert a measured pressure signal into an analog voltage signal and transmit the analog voltage signal to the micro controller 205. In one embodiment, the analog voltage signal is calculated by the micro controller 205 to determine the user's posture, and the user's posture is uploaded to a cloud by the wireless transmission unit 208. In another embodiment, the analog voltage signal is directly uploaded to the cloud by the wireless transmission unit 208, and the analog voltage signal is calculated in the cloud to determine the user's posture.

At least one of the plurality of pressure sensors 202 can be a flexible piezoresistive film sensor. In one embodiment, each of the plurality of pressure sensors 202 is the flexible piezoresistive film sensor. The flexible piezoresistive film sensors can be changed in shape with a body movement of users, thereby improving a comfortability of users. In one embodiment, each of the flexible piezoresistive film sensors comprises a polyethylene terephthalate (PET) film and a polymer composite material coating on surfaces of the PET film.

The number of the plurality of pressure sensors 202 and the size of each of the plurality of pressure sensors 202 can be adjusted according to actual needs.

The plurality of pressure sensors 202 is located on the health device body 100 and spaced from each other. In one embodiment, the plurality of pressure sensors 202 is located on an outer surface of the health device body 100 and spaced from each other. In one embodiment, at least one of the plurality of pressure sensors 202 is embedded in the health device body 100 and spaced from each other. In another embodiment, each of the plurality of pressure sensors 202 is embedded in the health device body 100 and spaced from each other. In one embodiment, the plurality of pressure sensors 202 is arranged symmetrically on the surface of the health device body 100. In another embodiment, the plurality of pressure sensors 202 is arranged symmetrically in the interior of the health device body 100.

The separation distance between two adjacent pressure sensors can be adjusted according to the structure of the health device body 100. In one embodiment, the distance between adjacent pressure sensors is in a range from about 5 centimeters to about 35 centimeters. In such range, a slight change in the user's posture can be sensitively sensed by the plurality of pressure sensors 202.

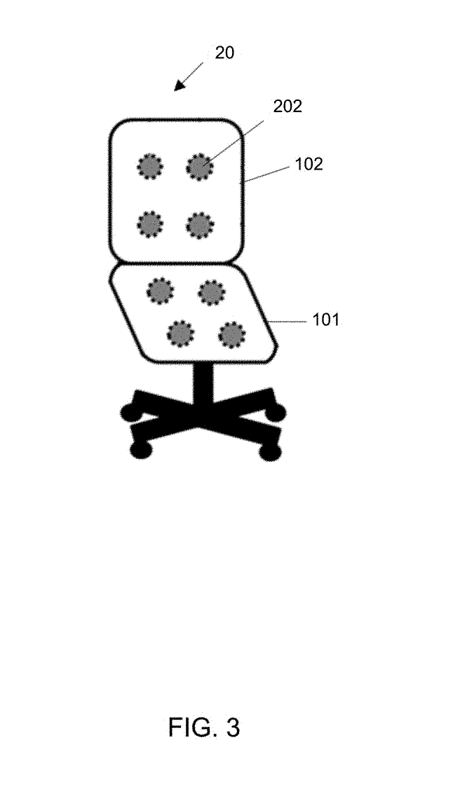

The shape of each of the plurality of pressure sensors 202 is not limited by what's shown in FIGS. 1 through 4. For example, the shape of each of the plurality of pressure sensors 202 can be circular or square. If the size of each of the plurality of the pressure sensors 202 is too large, the comfortability of the users will be reduced; on the contrary, if the size of each of the plurality of the pressure sensors 202 is too small, a sensing sensitivity will also be reduced. In one embodiment, the plurality of pressure sensors 202 may be circular, and a diameter of each of the plurality of pressure sensors 202 is ranged from about 0.2 inches to about 2 inches. In another embodiment, the plurality of pressure sensors 202 may be square, and a side length of each of the plurality of pressure sensors 202 is ranged from about 0.2 inches to about 2 inches. The size of each of the plurality of pressure sensors 202 is small, thus, the plurality of pressure sensors 202 occupy only a small portion of the health device body, the comfortability of the users will not be affected.

The reminder device 203 is used to remind users when they are seating with an unhealthy posture. The reminder device 203 can be a buzzer, a vibrator, an LED display or the like.

The battery system 204 can be any rechargeable battery such as battery pack or lithium-ion battery pack.

The multiplexer 2013 is a device that can output a signal from a plurality of analog or digital input signals through a control terminal (micro controller). The multiplexer 2013 is used to expand the number of controllable elements at the microcontroller I/O port. The memory integrated circuit 2011 is used for storing a related data of the user's posture for a long time. The charging module is used to charge the battery system 204.

### Example 1

Referring to FIGS. 1 to 3, the health device is a health chair 20. The health chair 20 comprises a chair body and the pressure sensing system 200. The pressure sensing system 200 is located on the chair body. The chair body includes a seat 101 and a seat back 102. The pressure sensing system 200 comprises the main circuit board 201, the plurality of pressure sensors 202, the reminder device 203, the battery system 204 and the wireless transmission unit 208.

The number of the plurality of pressure sensors 202 is eight. Four of the pressure sensors 202 are embedded in the seat 101 and located at four vertices of a square with a side length of twenty centimeters in the seat 101, and a center of the square is substantially at a center of the seat 101. The other four of the pressure sensors 202 are embedded in the seat back 102 and located at four vertices of a square with a side length of twenty centimeters in the seat back 102, and a center of the square is substantially at a center of the seat back 102.

The plurality of pressure sensors 202 convert the measured pressure signal into the analog voltage signal and transmit the analog voltage signal to the micro controller 205. The analog voltage signal is calculated by the micro controller 205 to determine the user's posture, and the user's posture is uploaded to the cloud by the wireless transmission unit 208.

Each of the plurality of pressure sensors 202 may be a flexible piezoresistive film sensor. Each of the plurality of pressure sensors 202 may include a PET film and a polymer composite material comprising nano powder, the polymer composite material comprising nano powder is printed on the PET film. Since the pressures applied to different pressure sensors 202 at different locations are different, the pressure sensors 202 at different locations will have different conductive paths, resulting in different conductivities. Through a linear conversion between current and pressure, the pressure change of each position can be detected.

The main circuit board 201 and the battery system 204 are located in the seat 101.

The plurality of pressure sensors 202 may be circular, and the diameter of each of the plurality of pressure sensors 202 may be about one inch. The pressure that each of the plurality of pressure sensors 202 can withstand is in a range from about 0 Psi to about 29 Psi.

The reminder device 203 is the LED display.

The battery system 204 is the Ni—MH battery pack. A capacity of the Ni—MH battery pack is about 4200 mAh. A rated voltage of the Ni—MH battery pack is about 3.6V.

In some embodiments, the plurality of pressure sensors 202 is located on a surface of the seat 101 and/or a surface of the seat back 102.

### Example 2

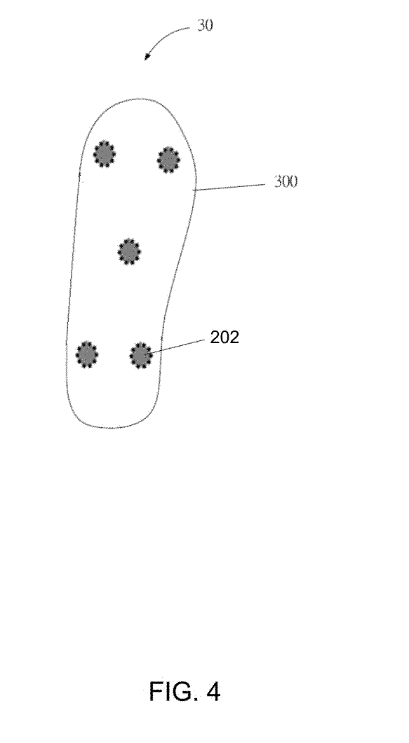

Referring to FIG. 4, the health device is an insole 30. The insole 30 comprises an insole body 300 and the pressure sensing system 200 as shown in FIGS. 1 and 2. The pressure sensing system 200 is located in the insole body 300. The pressure sensing system 200 comprises the main circuit board 201, the plurality of pressure sensors 202, the reminder device 203, the battery system 204 and the wireless transmission unit 208, where the main circuit board 201, the reminder device 203, the battery system 204 and the wireless transmission unit 208 are not explicitly shown in FIG. 4.

The number of the plurality of pressure sensors 202 is five. Two of the pressure sensors 202 are located in a sole position, two of the pressure sensors 202 are located in a heel position, and one of the pressure sensors 202 is located in a center position.

The plurality of pressure sensors 202 convert the measured pressure signal into the analog voltage signal, the analog voltage signal is directly uploaded to the cloud by the wireless transmission unit 208, and the analog voltage signal is calculated in the cloud to determine a user's standing posture.

Each of the plurality of pressure sensors 202 may be a flexible piezoresistive film sensor. Each of the plurality of pressure sensors 202 may include a PET film and a polymer composite material comprising nano powder, the polymer composite material comprising nano powder is printed on the PET film. Since the pressures applied to the pressure sensors 202 at different locations are different, the pressure sensors 202 at different locations will have different conductive paths, resulting in different conductivities. Through a linear conversion between current and pressure, the pressure change of each position can be detected.

The plurality of pressure sensors 202 may be circular, and the diameter of each of the plurality of pressure sensors 202 may be about 0.5 inches.

The reminder device 203 is the vibrator. A vibration can be generated to remind the user when the user is standing with the unhealthy posture.

The battery system 204 is the Ni—MH battery pack. The capacity of the Ni—MH battery pack is about 4200 mAh. The rated voltage of the Ni—MH battery pack is about 3.6V.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

The above-described embodiments are intended to illustrate rather than to limit the disclosure. Variations may be made to the embodiments without departing from the spirit of the disclosure as claimed. Elements associated with any of the above embodiments are envisioned to be associated with any other embodiments. The above-described embodiments illustrate the scope of the disclosure but do not restrict the scope of the disclosure.

What is claimed is:

1. A health device comprising:
a health device body; and
a pressure sensing system located on the health device body;
wherein the pressure sensing system comprises:
a plurality of pressure sensors spaced from each other;
a reminder device;
a battery system; and
a main circuit board electrically connected with the plurality of pressure sensors, the reminder device, and the battery system.

2. The health device of claim 1, wherein at least one of the plurality of pressure sensors is a flexible piezoresistive film sensor.

3. The health device of claim 2, wherein at least one of the flexible piezoresistive film sensors comprises a polyethylene terephthalate film and a polymer composite material coating on a surface of the polyethylene terephthalate film.

4. The health device of claim 1, wherein at least one of the plurality of pressure sensors is located on an outer surface of the health device body.

5. The health device of claim 1, wherein at least one of the plurality of pressure sensors is embedded in the health device body.

6. The health device of claim 1, wherein the plurality of pressure sensors is arranged symmetrically.

7. The health device of claim 1, wherein the pressure sensing system further comprises a wireless transmission unit.

8. The health device of claim 7, wherein the main circuit board comprises a micro controller; a measured pressure signal is converted into an analog voltage signal and transmitted to the micro controller by the plurality of pressure sensors; the analog voltage signal is calculated by the micro controller to determine a user's posture; and the user's posture is uploaded to a cloud by the wireless transmission unit.

9. The health device of claim 7, wherein a measured pressure signal is converted into an analog voltage signal by the plurality of pressure sensors; the analog voltage signal is uploaded to a cloud by the wireless transmission unit; and the analog voltage signal is calculated in the cloud to determine a user's posture.

10. The health device of claim 1, wherein a distance between adjacent pressure sensors is in a range from about 5 centimeters to about 35 centimeters.

11. The health device of claim 1, wherein at least one of the plurality of pressure sensors is circular, and a diameter of at least one of the plurality of pressure sensor is ranged from about 0.2 inches to about 2 inches.

12. The health device of claim 1, wherein at least one of the plurality of pressure sensors is square, and a side length of the at least one of the plurality of pressure sensors is ranged from about 0.2 inches to about 2 inches.

13. The health device of claim 1, wherein the main circuit board further comprises a memory integrated circuit, a charging module, and a multiplexer.

14. A health device comprising:
a chair body comprising a seat and a seat back; and a pressure sensing system located on the chair body, wherein the pressure sensing system comprises:
a first plurality of pressure sensors embedded in the seat and spaced from each other;
a second plurality of pressure sensors embedded in the seat back and spaced from each other;
a reminder device;
a battery system; and
a main circuit board electrically connected with the plurality of pressure sensors, the reminder device, and the battery system.

15. The health device of claim 14, wherein the pressure sensing system further comprises a wireless transmission unit.

16. The health device of claim 14, wherein the first plurality of pressure sensors is arranged symmetrically.

17. The health device of claim 14, wherein the second plurality of pressure sensors is arranged symmetrically.
